(19) United States
(12) Patent Application Publication
(10) Pub. No.: US 2008/0220719 A1
(43) Pub. Date: Sep. 11, 2008

(54) SYSTEM AND METHOD FOR PROVIDING MULTIMEDIA CONTENT TO A WIRELESS DEVICE

(75) Inventor: Ketul Sakhpara, Plano, TX (US)

Correspondence Address: TIMOTHY F. BLISS, P.O. BOX 793968, DALLAS, TX, 75379-3968, US

(73) Assignee: SAMSUNG ELECTRONICS CO., LTD., Suwon-city (KR)

(21) Appl. No.: 11/684,601

(22) Filed: Mar. 10, 2007

(51) Int. Cl. H04B 7/00

(52) U.S. Cl. 455/41.2

(57) ABSTRACT

The present disclosure relates generally to systems and methods for providing multimedia content to a wireless device. In one example, the method includes receiving a request from a wireless device to establish a connection to a telephone number. Multimedia content access information associated with the telephone number is identified, and the multimedia content access information is provided to the wireless device in response to the request to establish the connection. A request is received from the wireless device to access multimedia content associated with the multimedia content access information and the multimedia content is sent to the wireless device.

### BACKGROUND

Wireless devices, such as cellular phones and personal digital assistants, tend to have relatively small viewing screens. When combined with the control system of such devices, searching for and accessing remotely located multimedia content may be difficult. Accordingly, an improved method and system for providing multimedia content to a wireless device are needed.

### SUMMARY

In one embodiment, a method comprises receiving a request from a wireless device to establish a connection to a telephone number. Multimedia content access information associated with the telephone number is identified, and tile multimedia content access information is provided to the wireless device in response to the request to establish the connection. A request is received from the wireless device to access multimedia content associated with the multimedia content access information, and the multimedia content is sent to the wireless device.

In another embodiment, a method comprises sending, by a wireless device to a wireless network, a request to establish a connection to a telephone number. Multimedia content access information is received by the wireless device in response to tile request to establish a connection to the telephone number. A request to access multimedia content associated with the multimedia content access information is sent by the wireless device, and the multimedia content is received by the wireless device in response to the request to access the multimedia content.

In still another embodiment, a system comprises a content server, an application server, and a plurality of executable instructions. The content server is configured to distribute multimedia content. The application server is coupled to the content server and a wireless network. The plurality of executable instructions includes instructions for receiving, by the application server, a request from a wireless device via the wireless network to establish a connection to a telephone number: identifying, by the application server, multimedia content access information associated with the telephone number: providing, by the application server, the multimedia content access information to the wireless device in response to the request to establish the connection: receiving, by the content server, a request from the wireless device to access multimedia content associated with the multimedia content access information; and sending, by the content server, the multimedia content to the wireless device.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a flowchart illustrating one embodiment of a method for providing multimedia content to a wireless device.

FIG. 2 is a flowchart illustrating one embodiment of a method for accessing multimedia content by a wireless device.

FIG. 3 is a block diagram of one embodiment of a network within which the method of FIG. 1 may be implemented.

FIG. 4 is a sequence diagram illustrating one embodiment of a message flow between components of the network of FIG. 3.

FIG. 5 is a flowchart illustrating another embodiment of a method for providing multimedia content to a wireless device.

### DETAILED DESCRIPTION

It is to be understood that the following disclosure provides many different embodiments, or examples, for implementing different features of the disclosure. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Referring to FIG. 1, in one embodiment, a method 100 may be used to provide multimedia content to a wireless device. In the present example, multimedia content may include video and/or audio playable on the wireless device, such television shows, movies, music (e.g., from a radio station), or audio/video from concerts.

Currently, using multimedia content on a wireless device generally involves accessing a menu system to select the particular content that the user desires to listen to and/or watch. However, the size of the viewing screen and the controls on wireless devices such as cell phones make it difficult for a user to search for and select particular content. The interface is often based on a web-centric approach, which may be difficult for the user of a wireless device to navigate. The method 100 illustrates one embodiment of an improved approach for providing multimedia content to such a device.

In step 102, a request is received from a wireless device to establish a connection to a telephone number. In some examples, the telephone number may reflect the multimedia content with which it is associated (e.g., may include the name of a television show or movie). In step 104, multimedia content access information associated with the telephone number may be identified. For example, the telephone number may be associated with a particular Uniform Resource Locator (URL) in a database, and a database query for the telephone number may return the URL. In step 106, the multimedia content access information is provided to the wireless device.

In step 108, a request is received from the wireless device to access the multimedia content associated with the multimedia content access information. In step 110, the multimedia content is sent to the wireless device. The sending process may include sending a file that is stored on the wireless device or may include streaming the multimedia content to the wireless device. Accordingly, by dialing a telephone number, a user can access multimedia content without needing to access a menu to make a selection.

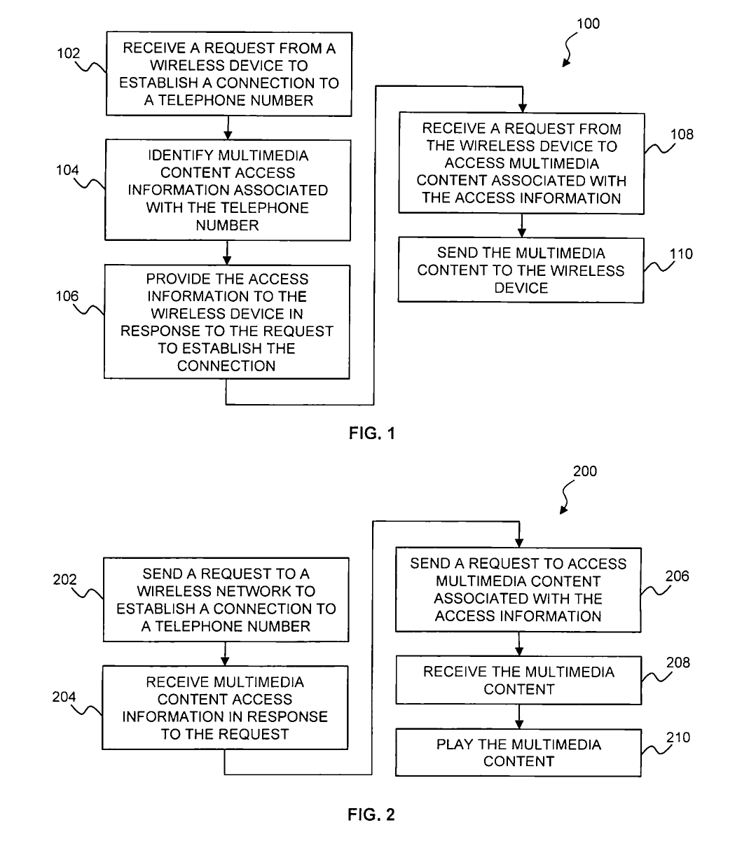

Referring to FIG. 2, in another embodiment, a method 200 may be used by a wireless device to access multimedia content. In step 202, the wireless device sends a connection request to a wireless network requesting that a connection be established with a particular telephone number. Instead of receiving connection information as would normally occur during a call setup, the wireless device receives multimedia content access information in step 204. As previously described, the multimedia content access information may be a URL or other packet connection address. In step 206, the wireless device sends a request for the multimedia content using the multimedia content access information. In steps 208 and 210, respectively, the wireless device receives the multimedia content and plays it.

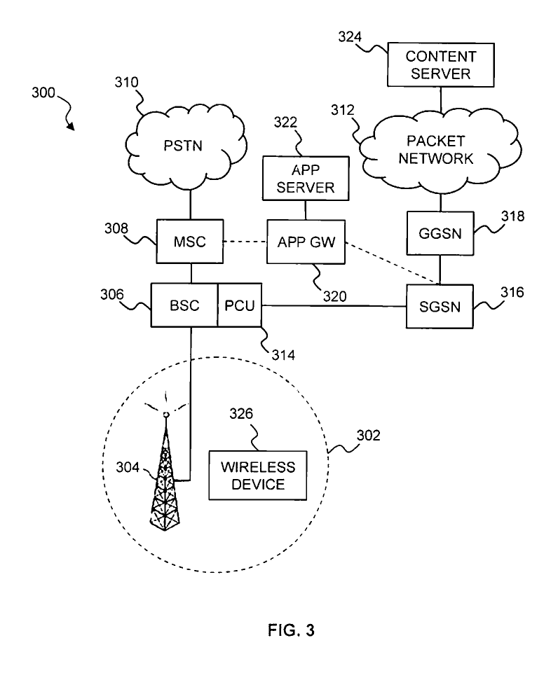

Referring to FIG. 3, in another embodiment, a portion of a wireless network 300 is illustrated. In the present example, the network 300 is based on Global System for Mobile communication (GSM) technology, but it is understood that the present disclosure may be implemented in any wireless network. For example, the present disclosure may be implemented in networks using Code Division Multiple Access (CDMA) technologies (including evolution data-only (EV-DO) architectures) based on Interim Standard 95 (IS-95). Interim Standard 2000 (IS-2000) and Universal Mobile Telecommunications System (UMTS). The network 300 may represent other technologies, including Orthogonal Frequency Division Multiplexing (OFDM). Accordingly, it is understood that the methods of the present disclosure may be performed in networks based on different technologies and that the example of a GSM network is for purposes of illustration only.

The network 300 comprises a plurality of cells, such as cell 302. It is understood that the cell may represent any subdivision (e.g., a cell, sector, or other network segment) of a wireless network. In the present example, the network 300 may be connected to other wireless and/or wireline networks, such as Public Switched Telephone Network 310 and packet network 312 (which may be any combination of private and public networks based on any packet technology, such as the Internet Protocol (IP) and the Transport Control Protocol (TCP)). Cell 302 includes base transceiver station (BTS) 304 that is coupled to base station controller (BSC) 306. A mobile switching center (MSC) 308 may be used to connect the network 300 with other networks, such as PSTN 310. Although not shown, the BSC 306 may be coupled to multiple BTSes, and the MSC 308 may be coupled to other BSCs.

The BSC 306 may include or be coupled to a Packet Control Unit (PCU) 314 that may be configured to handle packet data for the BSC and to couple the GSM portion of the network 300 with a General Packet Radio Service (GPRS) portion for data packets. The terms “packet” and “packet data”, as used in the present disclosure, may be interchangeable and may include any type of encapsulated data, including datagrams, frames, packets, and the like, and the encapsulated information may include voice, video, data, and/or other encapsulated information. The PCU 314 may be coupled to a Serving GPRS Support Node (SGSN) 316 that is coupled to the packet network 312 via a Gateway GPRS Support Node (GGSN) 318. In the present example, an application gateway 320 may be coupled to the MSC 308 and/or SGSN 316 receive application requests and pass them to an application server 322, as will be described below in greater detail. A content server 324 may be coupled to the network 300 via the packet network 312, although it is understood that the content server may be part of the network in some embodiments.

A wireless device 326 may communicate with the network 300 via the BTS 304 when positioned in the cell 302 (or in another cell associated with the network 300). In the present example, the wireless device 326 is a cell phone, but it is understood that the wireless device may be any device capable of wirelessly participating in a packet session, and such devices may include personal digital assistants, personal computers (e.g., laptops), and/or pagers

Although not shown, it is understood that some or all entities of the network 300 may include one or more processors, memories, and other components that enable the entities to receive, store, retrieve, process, and transmit instructions and data over wireless and/or wireline communication links. Furthermore, at least some functionality of an entity may be distributed and located elsewhere, either within a cell or outside of a cell. Repeaters (not shown) may be used to extend the range of the BTS 304.

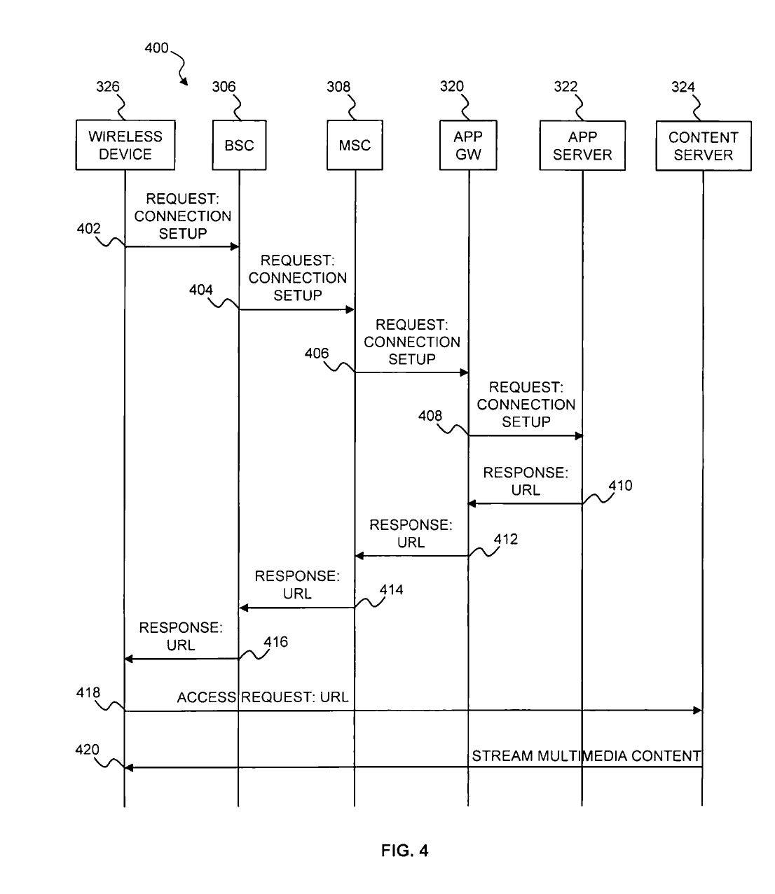

With additional reference to FIG. 4, a sequence diagram 400 illustrates one embodiment of a flow of messages that may occur within the network 300 of FIG. 3 to provide multimedia content to the wireless device 326. For purposes of example, assume that a user of the wireless device 326 wants to watch a television show that is associated with a particular 1-800 telephone number. The show is to be streamed and the user knows the time that the show will start.

In step 402, the wireless device 326 sends a connection request to the BSC 306 via the BTS 304 (not shown in FIG. 4). The connection request is initiated by the user dialing the 1-800 number. The connection request may be a request for the BSC 306 to initiate a connection to a telephone number contained in the request. In step 404, the BSC 306 sends the request to the MSC 308, which in turn sends the request to tile application gateway 320 in step 406. It is understood that processing may occur at various stages as the request is forwarded through the network 300, but such processing is known to those of skill in the art and is not described herein.

Upon receiving the request, the application gateway 320 forwards the request to the application server 322 in step 408. The application server 322, which is responsible for providing such services, processes the request and identifies access information (e.g., a URL) that corresponds to the request. In steps 410, 412, 414, and 416, the application server 322 sends the access information back through the network to the wireless device 326. For example, the access information may include a wireless application protocol (WAP) push trigger or a short message service (SMS)/enhanced SMS (EMS) trigger to redirect the wireless device 326 to a particular URL where the video content is located.

In step 418, the wireless device 326 sends a request, such as a hypertext transfer protocol (http) request through the network 300 to the content server 324. The content server 324, in response to the request, provides the associated multimedia content to the wireless device 326 in step 420. In some embodiments, steps 410-418 may be omitted. For example, the application server 322 may contact the content server 324 directly, and the content server may then send the multimedia content to the wireless device 326 in step 420.

Although not shown in FIGS. 3 and 4, it is understood that illustrated network entities or other entities not shown may be used to track and update billing information and authorization credentials, as well as perform other network functions. For example, the application gateway 320 may be responsible for handling billing and authentication functions for user requests. The application gateway 320 may determine whether the user is subscribed to a service required to access the multimedia content and may then forward the request to the application server 322 after verifying that the user has the proper credentials. In other embodiments, the billing function may be handled by a billing gateway (not shown) that may, for example, be positioned between the MSC 308 and the application gateway 320. Furthermore, the connection request may be identified as a service request by any network entity. Accordingly, it is understood that the functionality described in FIG. 4 and provided by the entities of FIG. 3 may be performed by entities other than those shown, may be combined into fewer entities, or may be further distributed.

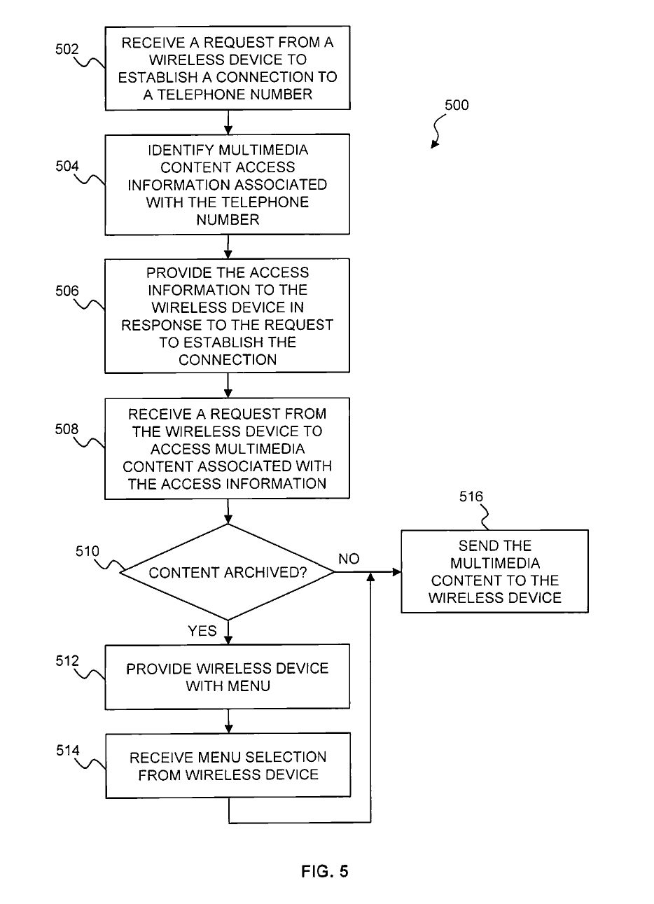

Referring to FIG. 5, in yet another embodiment, a method 500 may be used to provide multimedia content to a wireless device. In the present example, multimedia content may include video and/or audio playable on the wireless device.

In step 502, a request is received from the wireless device to establish a connection to a telephone number. In step 504, multimedia content access information associated with the telephone number may be identified. For example, the telephone number may be associated with a particular URL in a database, and a database query for the telephone number may return the URL. In step 506, the multimedia content access information is provided to the wireless device.

In step 508, a request is received from the wireless device to access the multimedia content associated with the multimedia content access information. In step 510, a determination may be made as to whether the requested content is archived. If the content is not archived, it may be live (in the case of a television show) or may be the only content located at that URL. For example, a television show may be accessible via a particular URL. The URL may link to that show while the show is live (e.g., airing) and/or for a particular period of time after the show ends. After the period of time expires, the URL may lead to an archive until the next iteration of the show airs. Alternatively, one URL may always link to the newest show, while another URL may link to the archive.

If the content is not archived, the method 500 moves to step 516, where the multimedia content is sent to the wireless device. As previously described, the sending process may include sending a file that is stored on the wireless device or may include streaming the multimedia content to the wireless device.

If the content is archived, the method 500 moves to step 512, where a menu (e.g., a dual tone, multi-frequency (dtmf) menu, a voice activated menu, or a web-based menu based a protocol such as hypertext markup language (html) or extensible markup language (xml)) may be provided to the wireless device. In other embodiments, a customer service representative may assist the user in accessing particular multimedia content. In step 514, a selection may be received from the wireless device and the method 500 may move to step 516, where content corresponding to the selection is sent to the wireless device.

Although only a few exemplary embodiments of this disclosure have been described in details above, those skilled in the art will readily appreciate that many modifications are possible in the exemplary embodiments without materially departing from the novel teachings and advantages of this disclosure. Also, features illustrated and discussed above with respect to some embodiments can be combined with features illustrated and discussed above with respect to other embodiments. Accordingly, all such modifications are intended to be included within the scope of this disclosure.

What is claimed is:

1. A method comprising:
receiving a request from a wireless device to establish a connection to a telephone number;
identifying multimedia content access information associated with the telephone number;
providing the multimedia content access information to the wireless device in response to the request to establish the connection;
receiving a request from the wireless device to access multimedia content associated with the multimedia content access information; and
sending tile multimedia content to the wireless device.

2. The method of claim 1 further comprising determining whether the multimedia content is archived prior to sending the multimedia content to the wireless device.

3. The method of claim 2 further comprising providing the wireless device with a menu if the multimedia content is archived.

4. The method of claim 3 further comprising receiving a message from the wireless device indicating a selection from the menu, wherein the multimedia content is sent to the wireless device based on the selection.

5. The method of claim 1 further comprising updating billing information corresponding to an account associated with the wireless device in response sending the multimedia content to the wireless device.

6. The method of claim 1 wherein sending the multimedia content to the wireless device includes sending a file containing the multimedia content to the wireless device, wherein the file is to be stored prior to being executed by the wireless device.

7. The method of claim 1 wherein sending the multimedia content to the wireless device includes streaming the multimedia content to the wireless device.

8. The method of claim 1 wherein identifying the multimedia content access information includes looking up a packet network address corresponding to the telephone number.

9. The method of claim 1 further comprising verifying that the wireless device is authorized to access the multimedia content.

10. A method comprising:
sending, by a wireless device to a wireless network, a request to establish a connection to a telephone number;
receiving, by the wireless device, multimedia content access information in response to the request to establish a connection to a telephone number;
sending, by the wireless device, a request to access multimedia content associated with the multimedia content access information; and
receiving, by the wireless device, the multimedia content in response to the request to access multimedia content associated with the multimedia content access information.

11. The method of claim 10 further comprising playing the multimedia content by the wireless device.

12. The method of claim 10 further comprising:
receiving, by the wireless device, a menu representing a plurality of multimedia content selections; and sending a message indicating a selection from the menu.

13. The method of claim 10 further comprising sending authorization information by the wireless device prior to receiving the multimedia content.

14. A system comprising:
a content server configured to distribute multimedia content;
an application server coupled to the content server and a wireless network; and
a plurality of executable instructions including instructions for
receiving, by the application server, a request from a wireless device via tile wireless network to establish a connection to a telephone number;
identifying, by the application server, multimedia content access information associated with the telephone number;
providing, by the application server, the multimedia content access information to the wireless device in response to the request to establish the connection;
receiving, by the content server, a request from the wireless device to access multimedia content associated with the multimedia content access information; and
sending, by the content server, the multimedia content to the wireless device.

15. The system of claim 14 further comprising an application gateway positioned between the application server and the wireless network and configured to identify the request to establish a connection to the telephone number as a service request for multimedia content and to direct the request to establish a connection to the telephone number to the application server.

16. The system of claim 14 wherein the multimedia content is a television show.

17. The system of claim 14 wherein the multimedia content is a movie.

18. The system of claim 14 wherein the instructions for sending, by the content server, the multimedia content to the wireless device, include instructions for streaming the multimedia content to the wireless device.

19. The system of claim 14 wherein the instructions for sending, by the content server, the multimedia content to the wireless device, include instructions for sending a file containing the multimedia content to the wireless device, wherein the file is to be stored prior to being played by the wireless device.

20. The system of claim 14 wherein the instructions further include instructions for providing the wireless device with a menu if the multimedia content is archived, and instructions for receiving a message from the wireless device indicating a selection from the menu, wherein the multimedia content is sent to the wireless device based on the selection.
